(19) United States
(12) Patent Application Publication
(10) Pub. No.: US 2007/0034780 A1
(43) Pub. Date: Feb. 15, 2007

(54) Light intensity sensor for optical fibers

(76) Inventor: Andrew Sterian, Grandville, MI (US)

Correspondence Address: Jeffrey S. Kapteyn;Price, Heneveld, Cooper, DeWitt & Litton, LLP, 695 Kenmoor, S.E., Post Office Box 2567, Grand Rapids, MI, 49501, US

(21) Appl. No.: 11/500,016

(22) Filed: Aug. 7, 2006

Related U.S. Application Data
(60) Provisional application No. 60/706,075, filed on Aug. 5, 2005.

(51) Int. Cl. H01J 40/14

(52) U.S. Cl. 250/214 R

(57) ABSTRACT

A light intensity sensor includes photodiode or other light sensitive device, and a capacitor connected to the photodiode. A microcontroller measures the time interval required for the capacitor to reach a predetermined voltage level. The current produced by the photodiode as a function of the light intensity is known, such that the time interval can be used to determine the light intensity. The microcontroller is configured to reset the capacitor voltage to zero after the predetermined voltage level is reached, and the measuring process is repeated.

### CROSS-REFERENCE TO RELATED APPLICATIONS

This application claims the benefit of U.S. Provisional Application No. 60/706,075, filed Aug. 5, 2005, the entire contents of which is hereby incorporated by reference.

### BACKGROUND OF THE INVENTION

Fiber optic circuits generally include a transmitter such as a laser that converts an electrical signal (electrical energy) into a light signal (light energy) and injects the light into an optical fiber. A receiver coupled to the optical fiber converts the light energy into electrical energy after the light signal is transmitted through the optical fiber. A known circuit for converting light energy into electrical energy is known as a transimpedance amplifier (FIG. 3).

A photodiode D₁ is a transducer that converts light energy into an electrical current I_{d}. The amount of current is, to a first approximation, linearly proportional to the amount of light energy seen by the diode. This current is generally very small, no more than a few microamps. In order to magnify this current into a quantity usable by digital electronics, the transimpedance amplifier produces a voltage that is proportional to the current I_{d} and is a much larger, more usable quantity.

For the prior art circuit of FIG. 3, it can be shown that with ideal components, the voltage at the node labeled Vₒᵤₜ is given by the equation:
Vₒᵤₜ=(R₁+R₂)I_{d}

By choosing large resistors R₁ and R₂ (typically in the mega-ohm range), the output voltage can be on the order of volts even though the photodiode current is on the order of microamps. The operational amplifier U₁ in the circuit of FIG. 3 is necessary so that digital components that attempt to measure the voltage Vₒᵤₜ do not disturb the operation of the circuit. The prior art circuit of FIG. 3 is typically utilized in fiber optic communications systems requiring virtually instant sensing of light intensity.

The transimpedance amplifier circuit of FIG. 3 has several disadvantages. First, the circuit of FIG. 3 is highly sensitive to variations in photodiode current that may be caused by variations of temperature or physical mounting and coupling. Over a temperature range of −40° C. to +100° C., an Optek OP999 photodiode (for example) exhibits a variation of anywhere from one one-thousandth ( 1/1000) to 1000 times the “dark current” (current I_{d} when no light shines on the photodiode) at +25° C. With fixed resistors R₁ and R₂, the output voltage Vₒᵤₜ will vary greatly with temperature. Additional circuitry may be required to compensate for the inflexibility of R₁ and R₂ and thus compensate for the large variations in current. In use, the photodiode is mechanically coupled to an optical fiber. Variations in the quality of the coupling leads to variations in the amount of light incident upon the photodiode from one assembly to another. Also, the operational amplifier U₁ adds to the system cost and increases circuit board area. Finally, the analog output voltage VOU, requires that the external digital circuitry contain an analog-to-digital converter (A/D) in order to make use of this voltage in a digital control algorithm, potentially increasing system cost. Due to the large variations in expected current it is generally not sufficient to simply use a comparator instead of an A/D converter as the trip-point of the comparator would have to adapt to the variations in current.

### BRIEF DESCRIPTION OF THE DRAWINGS

FIG. 1 is a circuit according to one aspect of the present invention;

FIG. 2 is a graph of the time-domain behavior of the circuit of FIG. 1;

FIG. 3 is a prior art circuit; and

FIG. 4 is another circuit.

### DETAILED DESCRIPTION OF PREFERRED EMBODIMENT

The present application is related to U.S. patent application Ser. No. ______, entitled TEMPERATURE SENSING CIRCUIT, filed on even date herewith using Express Mail No. EV592299131US, the entire contents of which are incorporated by reference.

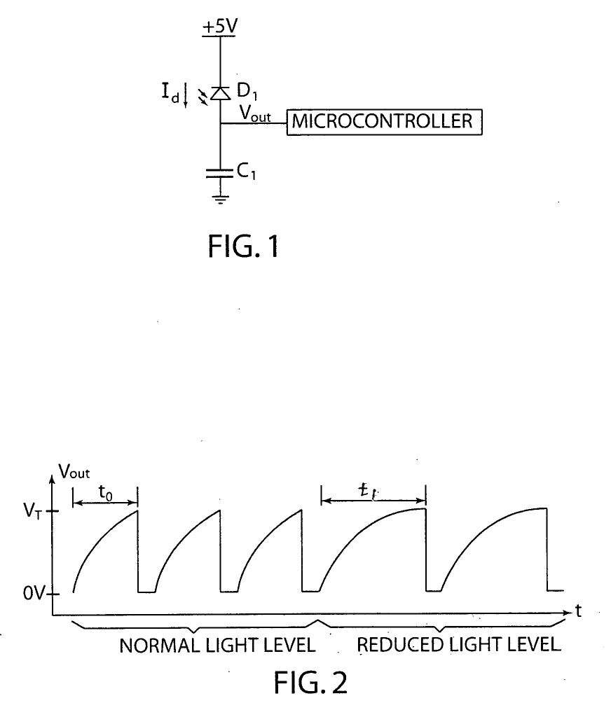

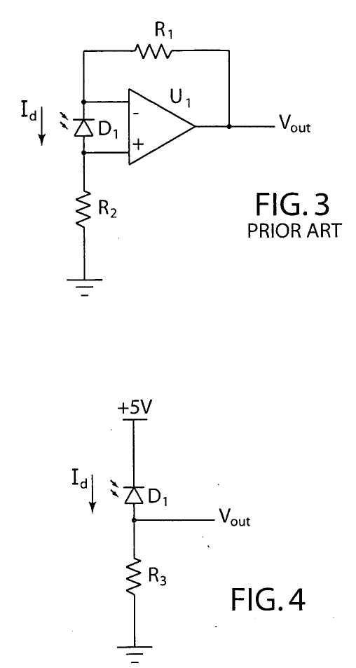

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

An electronic circuit according to the present invention (FIG. 1) detects changes in the intensity of light in an optical fiber. The circuit may be utilized to detect changes in light intensity that are the result of pressure applied at a point along the length of an optical fiber. An example of an optical fiber pressure sensor that utilizes changes in light intensity to sense pressure is disclosed in U.S. Pat. No. 6,912,912, issued on Jul. 5, 2005, the entire contents of which are incorporated by reference. The circuit of FIG. 1 includes a photodiode, a capacitor, and a microcontroller. Additional circuitry and wiring (not shown) of a known type may be utilized to provide for proper operation of the microcontroller.

The capacitor C₁ is initially discharged such that the potential at node Vₒᵤₜ is 0V (or “ground”). The photodiode D₁ converts light energy into an electrical current I_{d}. The current charges the capacitor C₁ and increases the voltage at the node Vₒᵤₜ. The microcontroller senses this voltage and measures the length of time required for the voltage to reach a predetermined voltage level V_{T}. This time is a function of the light level, and therefore provides a measurement of the light energy. The longer it takes for Vₒᵤₜ to reach the specified voltage level V_{T}, the lower the light energy.

After the microcontroller has detected that Vₒᵤₜ has reached V_{T}, the microcontroller then discharges the capacitor C₁ using the same pin that was used for sensing Vₒᵤₜ. That is, the pin changes direction from being an input signal to the microcontroller to become an output signal that is set to 0 volts. The effect of this action is to set Vₒᵤₜ to 0 and allow for another capacitor charging process to begin. In this fashion, consecutive repeated measurements are taken.

To detect pressure applied at a point along the length of an optical fiber, the time it takes for Vₒᵤₜ to reach V_{T} is initially measured, averaged, and stored in the microcontroller memory. After this initial set-point calibration is complete, consecutive repeated measurements are taken as described above. If the time it takes Vₒᵤₜ to reach V_{T} exceeds the initial measurement by some specified amount, the application of pressure is detected and reported.

The time-domain behavior of the circuit is illustrated in FIG. 2. At the nominal (“Normal”) light intensity level, the capacitor voltage Vₒᵤₜ takes t₀ seconds to charge from 0 volts to V_{T} volts. After this time, the microcontroller forces the signal Vₒᵤₜ to 0 volts. After a short duration during which the capacitor C₁ is allowed to discharge, the microcontroller stops forcing the voltage at Vₒᵤₜ to 0 volts and allows the photodiode to charge the capacitor C₁ again. When the light intensity is reduced, the capacitor C₁ charges more slowly (due to the reduced current I_{d}) and it now takes t₁ seconds to charge the capacitor C₁ from 0 volts to V_{T} volts. The microcontroller detects this change in time and reports the reduction of light intensity. Although the circuit of FIG. 4 is believed to be novel, it is not as flexible as the circuit of FIG. 1 for those reasons described in more detail above.

FIG. 4 shows another prior art circuit. Even though the circuit of FIG. 4 may appear to generate a voltage Vₒᵤₜ=R₃I_{d} that can be made large enough to be usable, an attempt to connect the node Vₒᵤₜ to an actual digital device typically renders the circuit unusable. This is because the leakage currents of digital devices are large relative to the photodiode current.

It will be readily apparent to those skilled in the art that other variations of the light intensity circuits just described may be utilized. For example, other light-sensitive devices such as a phototransistor may be utilized in place of the photodiode. Also, the microcontroller may comprise circuit elements configured to provide the functions of the microcontroller.

The circuit of the present invention provides several benefits. First, no operational amplifier is necessary. The circuit according to the present invention can be described as converting current to time. The lower the current, the longer the time it takes to charge the capacitor C₁ to a specified voltage level. Varying conditions of temperature, fiber mechanical coupling, etc. will only lead to variations in this time interval and do not require any change to or adaptation of the fixed circuit components (photodiode and capacitor). Variations in the time interval can be compensated in the microcontroller software. Also, the microcontroller does not need to have an A/D converter. The microcontroller will generally have a built-in analog comparator, but a full-fledged A/D converter is not required. Thus, a wider range of microcontrollers may be utilized. Finally, the microcontroller may not need to have a comparator. A digital input pin of the microcontroller may be used as a rudimentary comparator. Because digital inputs recognize only one of two states, logic low and logic high, some voltage threshold exists within the microcontroller which serves as the specified required voltage level for Vₒᵤₜ.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A light intensity sensor, comprising:
an electrical power source;
a photodiode connected to the power source and defining a voltage at a node opposite the electrical power source, the photodiode providing an electrical current that varies a result of an intensity of light incident on the photodiode;
a capacitor connected to the photodiode; and
a controller configured to measure the length of time for the voltage to go from a first predetermined value to a second predetermined value and thereby determine the intensity of light incident on the photodiode.

2. The light intensity sensor of claim 1, wherein:
the controller comprises a microcontroller.

3. The light intensity sensor of claim 1, wherein:
the controller discharges the capacitor after the voltage reaches the second predetermined value and thereby set the voltage at the first predetermined value.

4. The light intensity sensor of claim 1, wherein:
the first predetermined voltage is ground.

5. The light intensity sensor of claim 1, wherein:
the sensor generates a signal if the length of time for the voltage to go from the first predetermined value to the second predetermined value is greater than a specified length of time.
